(19) United States
(12) Patent Application Publication
(10) Pub. No.: US 2025/0238042 A1
(43) Pub. Date: Jul. 24, 2025

(54) SYSTEM AND METHOD FOR A DASHBOARD ORNAMENTAL OBJECT

(71) Applicant: Johnson Darin N., Meridian, ID (US)

(72) Inventor: Johnson Darin N., Meridian, ID (US)

(21) Appl. No.: 19/003,193

(22) Filed: Dec. 27, 2024

Related U.S. Application Data
(63) Continuation-in-part of application No. 18/420,265, filed on Jan. 23, 2024, now abandoned.

(51) Int. Cl. G05D 3/12; B60R 13/00

(52) U.S. Cl. CPC G05D 3/12; B60R 13/00

(57) ABSTRACT

A system and method for a dashboard ornamental object having an accelerometer sense movement in the vehicle and sends outgoing signals to be received by a circuit board capable of receiving such outgoing signals. Computer code then manipulates the outgoing signals from the accelerometer, by amplifying inputs for slower movements and averaging the data signals to reduce noise and irregular jolts, and sends a corresponding signal to the servomechanism. A stand holds the servo on the dash of a vehicle and a servo arm rotates an ornamental object clockwise or counterclockwise according to the turn direction of the vehicle.

### CROSS REFERENCE TO RELATED APPLICATIONS

This application is a continuation in part that claims priority to U.S. patent Ser. No. 18/420,265 filed Jan. 23, 2024 and is incorporated in its entirety.

### FIELD OF DISCLOSURE

The overall field of this invention relates to vehicle accessories, and more particularly to an ornament that senses an acceleration during the turn of a moving vehicle and rotates in the direction of the turn.

### BACKGROUND

The driving experience is different for many, from the mundane drive of the destination focused, to the acceleration thrill seeker. Though purposes may be different, a common sentiment for all is the desire to add to and share their experience, a way of personalizing and enjoying their vehicle with an identifiable touch. Decorated with bumper stickers, custom labels for license plates, window stickers, and other forms of art, we can see the desires of drivers to enjoy and share the journey. These forms of expressions, visible from outside the vehicle, leave the occupants to a limited choice of interior enjoyment. The destination focused is left with routine boredom. For the single occupant, no sidekick or companion to share the journey. For the road rager, no joyful consoler. For the bored occupants, a mundane portage. Thus exists the need for a new way of enhancing the driving experience within the vehicle; a joyful addition to the destination driver, an entertaining wingman for the single occupant, the opportunity of a smile to the raged, and a sharable form of accelerative experience to the thrill seeker.

### SUMMARY

The present invention is directed to a dashboard ornamental object where an accelerometer, pendulum, or vehicle's accelerometer senses centripetal acceleration when the vehicle turns and sends outgoing signals to be received by a circuit board capable of receiving such outgoing signals. Computer code then manipulates the outgoing signals from the accelerometer, by amplifying inputs for slower movements and averaging the data signals to reduce noise and irregular jolts, and sends a corresponding signal to the servomechanism (servo). A stand holds the servo on the dash of a vehicle and a servo arm rotates an ornamental object clockwise for right hand turns, or counterclockwise for left hand turns.

### BRIEF DESCRIPTION OF DRAWINGS

The present invention will be described by way of exemplary embodiments, but not limitations, illustrated in the accompanying drawings in which like references denote similar elements, and in which:

FIG. 1 shows a block diagram of the dashboard ornamental object system.

FIG. 2 shows an illustration of the ornamental coordinate system for the ornament.

FIG. 3 shows an illustration of the circuit board.

FIG. 4 shows an illustration of the ornamental coordinate system inside a vehicle.

FIG. 5 illustrates the rotational angles of the ornamental object.

### DETAILED DESCRIPTION

In the Summary above and in this Detailed Description, and the claims below, and in the accompanying drawings, reference is made to particular features of the invention. It is to be understood that the disclosure of the invention in this specification does not include all possible combinations of such particular features of other particular aspects and embodiments of the invention, and in the invention generally.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

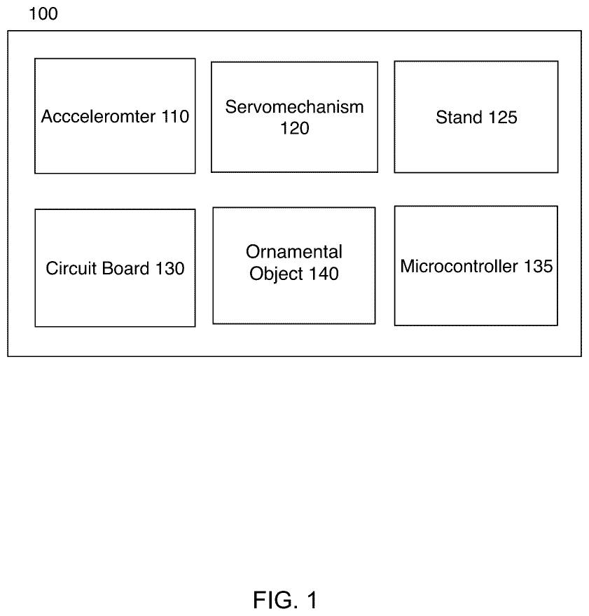

Referring now to FIG. 1, FIG. 1 is a block diagram of dashboard ornamental object system 100 automatically activated by the movement of a motor vehicle in accordance with the present invention. Dashboard ornamental object system 100 may include one or more components such as an accelerometer 110, a servomechanism 120, a stand 125, a circuit board 130 of a control system having a microcontroller 135 with one or more processors to enable the steps of this invention, and an ornamental object 140 which moves in response to the acceleration of vehicle 200 to improve the driving experience of the user. It should be appreciated that the term vehicle may be used for any number of vehicles such as a boat or bike.

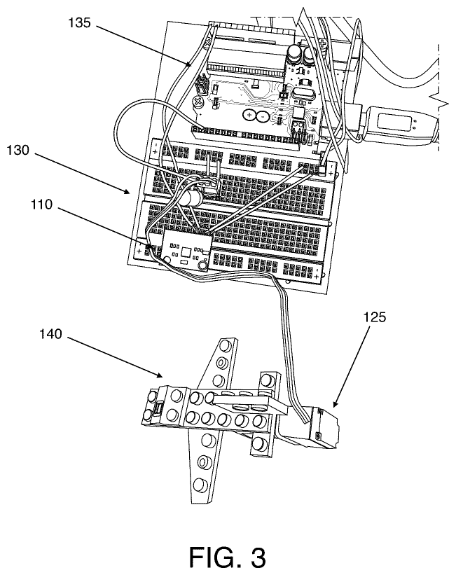

Accelerometer 110 is a sensor that measures acceleration or the change of velocity with respect to time in the vehicle whereby accelerometer 110 is connected to a vehicle's electrical system, as illustrated in FIG. 3 Accelerometer 110 may be a microelectromechanical systems (MEMS) accelerometer that mechanical structures such as microscale springs or beams and microelectronics to convert mechanical motion into an electrical signal. When accelerometer 110 experiences acceleration, the mechanical structures move, causing a change in electrical properties such as a capacitance or resistance, which is then measured to determine the acceleration. Accelerometer 110 may then provide analog or digital output signals that represent the measured acceleration along the x-axis. These signals can be processed by electronic circuits or microcontroller 135 on circuit board 130 for further analysis.

In other non-limiting embodiments, accelerometer 110 may possibly be replaced by a signal from the vehicle given that the vehicle can sense acceleration and that the signal can be extracted. For instance, the accelerometer, and all electrical components, may be replaced with a pendulum which may be connected to ornamental object 140.

In one embodiment accelerometer 110 may be a 3-axis accelerometer and have 3-axis gyroscope inside it. Accelerometer 110 may include a power supply of 3-5V and have a I2C protocol, a built-in 16-bit ADC, a built-in DMP, and a temperature sensor. Accelerometer 110 may have the following pin configuration: 1. VCC which provides power for the module. 2. Ground. 3 Serial Clock used for providing clock pulse for I2C Communication. 4 Serial Data (SDA) used for transferring data through I2C communication. 5. Auxiliary Serial Data (XDA) which used to interface other I2C modules with accelerometer 110. 6. Auxiliary Serial Clock (XCL) which is used to interface other I2C modules with accelerometer 110. 7 AD0 which is used to vary the address. 8 Interrupt (INT) which is used to indicate that data is available for reading.

In further embodiments accelerometer may be on a remote computing device connected by a wireless communication interface, which may be a digital, analog, or mixed-signal circuit to transmit wireless signals indicating input received from remote computing device such as a mobile phone, computer, a wearable device, tablet, a virtual reality system. The wireless signals may be transmitted to microcontroller 135 such as a phone, a computer, a wearable device, tablet, a virtual reality system, etc. The wireless communication interface may send and receive data via a wireless network such as sending acceleration data from the remote computing device to ornamental object 140.

Circuit board 130 may include a microcontroller 135 and a set of digital input/output (I/O) pins and analog input pins to connect to accelerometer 110 and servomechanism 120 whereby digital inputs may be configured as either inputs or outputs, while analog pins are used to read analog sensor values. Circuit board 130 may be powered through various sources, including USB connections, external power supplies, or batteries, depending on the specific board model. Microcontroller 135 may include a programming interface whereby a user may write code upload it to microcontroller 135 via a USB connection, and execute the code on microcontroller 135. In further embodiments circuit board 130 may be wireless having an antenna and a radio frequency module enables the circuit board to communicate over radio frequencies for sending and receiving signals wirelessly.

Microcontroller 135 may include a clock crystal or oscillator to provide precise timing for microcontroller 135. Microcontroller 135 may include an onboard reset button that allows the user to restart circuit board 130 and reload new code. Circuit board 130 may include headers and connectors for easy attachment of hardware components, as well as shields which may stacked on top of circuit board 130.

Servomechanism 120 may be designed to provide rotational angular displacement or angular velocity to ornamental object 140. Servomechanism 120 may be a servo motor with arms, which is a specific type of motorized mechanism such as a stepper motor that combines a servo motor with one or more mechanical arms or linkages. These arms are attached to the output shaft of servomechanism 120 and may manipulate the ornamental object 140. Servomechanism 120 may include rotary actuator that allows for precise control of angular position. Servomechanism 120 may include a motor, a control circuit for controlling the motor, a gearbox with one or more gears that transform speed into torque, and a feedback mechanism such as a potentiometer or an encoder that provides position feedback to microcontroller 135 and keeps track of the angle. Servomechanism 120 may include a set of three wires including a PWR, GND and Signal.

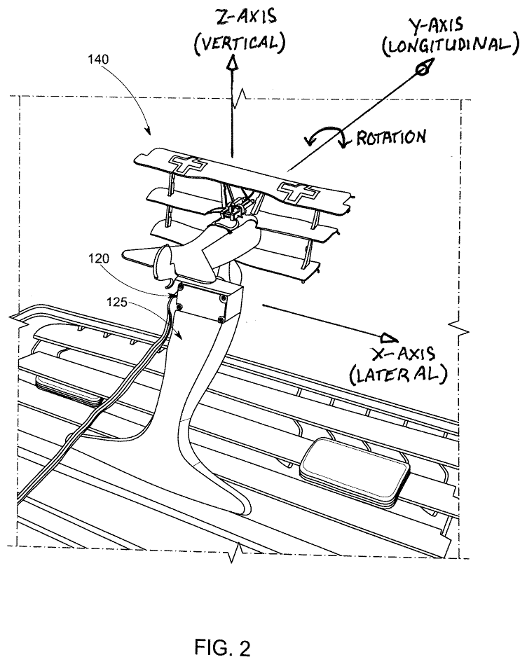

Servomechanism 120, circuit board 130, and accelerometer 110 may be positioned in a stand 125 that is positioned on the dash of a vehicle whereby stand 125 acts as housing for the various features with servomechanism 120 placed at a top of stand 125, as illustrated in FIG. 2. Stand 125 may be made of any material such as clay, plastic, metal, cardboard, urethane, rubber, wood, etc. Stand 125 may include a power source such as a 9 volt battery or a plug that connects to a power source of the vehicle such as a USB outlet or cigarette lighter. Servomechanism 120 may be directly connected to ornamental object 140 by any number of fasteners such as a magnet which allow the user to select and replace with a custom object of their own choice that may be attached to accelerometer 110 via the magnet. Ornamental object 140 may be any number of items such as but not limited to an airplane, automobile, boat, human, animal, super hero figure, or a paper airplane. During use, when the vehicle turns left, ornamental object 140 mimics the motion by rotating counterclockwise. Likewise, ornamental object 140 will rotate clockwise when the vehicle turns right.

During use to translate acceleration to rotational movement, accelerometer 110 may detect changes in velocity along the x-axis (lateral). These sensors output raw data that corresponds to centripetal acceleration acting on the vehicle. For example, the x-axis data may reflect the acceleration of the vehicle during a turn.

Using a predefined transformation matrix or algorithm, the accelerometer data may then be processed by Dashboard ornamental system 100 to generate the rotational motion of ornamental object 140.

The car's lateral (x-axis) accelerations may be used to derive the corresponding rotation angles for dashboard ornamental system 100 about the y-axis (longitudinal). The accelerometer data is then processed and dashboard ornamental object system 100 outputs the rotational motion data. The system operates in real-time, continuously receiving new accelerometer data and updating the motion profile as the vehicle's movement changes. This ensures that the conversion to the ornament's motion is accurate and up-to-date, providing seamless and realistic transition behavior between the vehicle and ornament.

For initial installation the user may connect the VCC and GND pins of the accelerometer to the appropriate power source. The user may then connect the SDA and SCL pins of the accelerometer to the corresponding pins on the microcontroller 135 (e.g., A4 and A5 on circuit board 130 for I2C communication). The user may then connect the signal wire of the servomechanism 120 to one of the PWM pins on microcontroller 135.

The computer code from circuit board 130 may initialize accelerometer 110 and servomechanism 120. Microcontroller 135 may then read the accelerometer data such as the centripetal acceleration and map it to servomechanism 120 desired angle range whereby mapped values may be to set the position of servomechanism 120.

The computer code may be designed to clean up the data received from accelerometer 110 by averaging the data to reduce the noise and irregular jolts from the accelerometer 110. This helps prevent erratic movement from impact accelerations. The computer code may limit the angle of servomechanism 120 and ignores certain outputs to keep chatter down. For example, ignoring a range of angles near the “static” position of ornamental object 140 will keep it from jittering back and forth from every small acceleration that is sensed by the accelerometer 110. It will likewise limit the maximum angle so the rotation of ornamental object 140 is more natural to the movement of a banking airplane. Additionally, computer code may amplify the inputs from accelerometer 110 so that the ornament will rotate a satisfactory amount with slower vehicle movements. For example, a slow turn of the vehicle will produce the same rotational angle as a high-speed turn.

Dashboard ornamental object system 100 may implement a parabolic control algorithm to achieve enhanced stability and responsiveness in servo positioning applications.

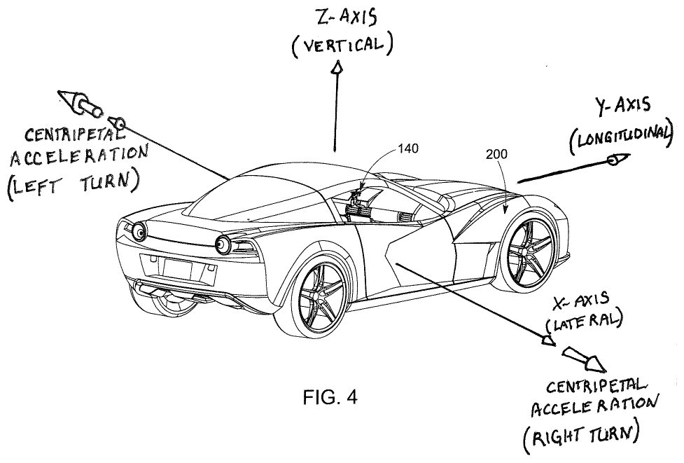

Dashboard ornamental object system 100 receives raw accelerometer values within a range of −17,000 to 17,000 units. However this is non limiting and may be any unites depending on the type of accelerometer. The vertical z-axis is defined at the 90 degree angle, and is orthogonal to the lateral x-axis and longitudinal y-axis plane of the vehicle as illustrated in FIG. 4.

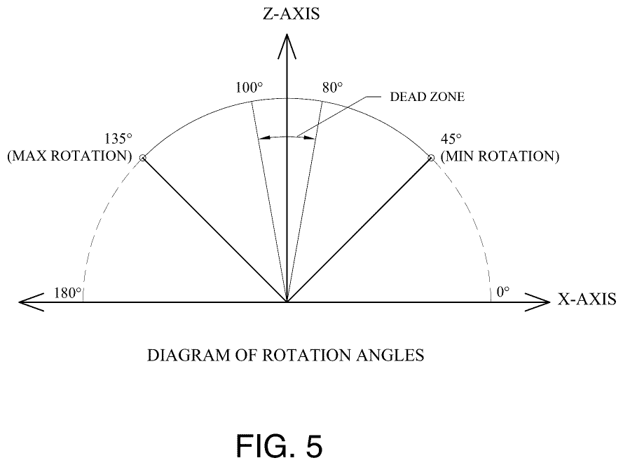

Dashboard ornamental object system 100 may implement a dead zone between 80 and 100 degrees, centered on a neutral position of 90 degrees, wherein the servo maintains its neutral position to prevent unwanted oscillation. For values outside this dead zone, the system applies a non-linear transformation using a power function with an exponent of 1.2 for values outside the dead zone and constraining final output between 45 and 135 degrees as illustrated in FIG. 5.

For input values exceeding 100 degrees, the processor calculates a new position according to the formula: new_position=average+(average−90)\hat{ }1.2−25.

For input values below 80 degrees, the processor calculates a new position according to the formula: new_position=average−(90−average)\hat{ }1.2+25.

Dashboard ornamental object system 100 may implement hardware limits constraining the final angle output between 45 and 135 degrees to prevent mechanical overextension. When in use servo control methodology provides enhanced stability near the neutral position while maintaining responsive movement for larger deflections.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A vehicle dashboard ornamental object system comprising: a) an accelerometer configured to sense centripetal acceleration of a vehicle; b) a controller coupled to the accelerometer, the controller configured to: i) receive acceleration data from the accelerometer; ii) convert the acceleration data into rotational angles about an axis; and iii) output a control signal corresponding to the rotational angles; c) a servomotor coupled to the controller, the servomotor configured to receive the control signal and rotate an ornamental object in response thereto about an axis parallel to a longitudinal y-axis of the vehicle, wherein the ornamental object coupled to the servomotor, the ornamental object configured to rotate in response to rotation of the servomotor; whereby the ornamental object rotates clockwise when the vehicle turns right, and rotates counter-clockwise when the vehicle turns left.

2. The system of claim 1, wherein the servomotor is configured to define a vertical z-axis at a 90 degree angle to a lateral x-axis and longitudinal y-axis plane of the vehicle.

3. The system of claim 2, wherein the vehicle x-axis is a direction of the centripetal acceleration when the vehicle is turning.

4. The system of claim 1, wherein the controller is further configured to: a) map the acceleration data to the rotational angles from 0 to 180 degrees; b) maintain a rolling average the mapped angles to smooth the data; and c) modify the mapped rotational angles using a non-linear transformation function.

5. The system of claim 4, wherein the controller is further configured to: output a neutral control signal of 90 degrees when averaged angle values fall between 80 and 100 degrees.

6. The system of claim 4, wherein for the rotational angles below 80 degrees, the controller modifies angle values using the transformation function: new_angle=average_angle−(90−average_angle)\hat{ }1.2+25.

7. The system of claim 4, wherein for the rotational angles exceeding 100 degrees, the controller further modifies angle values using the transformation function: new_angle=average_angle+(average_angle−90)\hat{ }1.2−25.

8. The system of claim 4, wherein the controller is further configured to limit the output angles to a range of 45 degrees to 135 degrees.

9. The system of claim 1, wherein the ornamental object representing a physical object wherein the ornamental object is user-interchangeable with different decorative objects.

10. The system of claim 9, wherein the ornamental object resembles an airplane, and a fuselage of the airplane is parallel with the longitudinal y-axis of rotation of the servomotor.

11. The system of claim 1, wherein the vehicle is a land vehicle such as a car, truck, or motorcycle.

12. A vehicle dashboard ornamental object system for automatically activating movement of an ornamental object comprising: an inertial sensor configured to detect centripetal acceleration of a turning land vehicle; a servomotor to receive a control signal thereby applying angular displacement to the ornamental object, and a control system connected to the inertial sensor and the servomotor.

13. The system of claim 12, wherein the control system is further configured to: receive raw accelerometer values; map the raw accelerometer values to a primary angle variable ranging from 0 to 180 degrees; and send a control signal angle to the servomotor.

14. The system of claim 12, wherein the control system is further configured to: process accelerometer data from the vehicle's centripetal acceleration to derive roll angle signals and send those signals to the servomotor thereby rotating the ornamental object in real-time as the vehicle turns.

15. The system of claim 14, further comprising: the control system configured to: average the accelerometer data to reduce noise; amplify output signals to the servomotor thereby increasing ornamental object rotation during slow vehicle turning rates.

16. The system of claim 12, further comprising: the ornamental object is coupled to the servomotor.

17. The system of claim 16, wherein the coupling system is a magnet; wherein the ornamental object is easily interchangeable with different decorative ornaments.

18. A dashboard ornamental display system comprising: a stand configured to be mounted on a vehicle dashboard; an ornamental object representing an airplane coupled to a servomotor, wherein the servomotor is housed within the stand, wherein the airplane is user-interchangeable with different ornamental figurines; an inertial sensor configured to detect centripetal acceleration of the vehicle during a turn; and a control system configured to: receive acceleration data from the inertial sensor and transmit rotational signals to the servomotor; thereby rotating the ornamental object counter-clockwise when the vehicle turns left, and rotating the ornamental object clockwise when the vehicle turns right.

19. The dashboard ornamental display system of claim 18 wherein the control system is configured to: receive raw accelerometer values from an accelerometer; map the raw accelerometer values to a primary angle; maintain a rolling average of the mapped values in an averaging variable to smooth data; thereby creating signals for new servo positions corresponding to inertial input values.

20. The dashboard ornamental display system of claim 19 wherein the primary angle is variable from 45 to 135 degrees.
